(19) United States
(12) Patent Application Publication
(10) Pub. No.: US 2015/0206175 A1
(43) Pub. Date: Jul. 23, 2015

(54) METHOD OF GENERATING QUALIFIED SALES LEADS

(71) Applicant: Marketing Tactics pty Ltd, Bundall (AU)

(72) Inventor: Marc CARRIERE, Bundall (AU)

(73) Assignee: Marketing Tactics pty Ltd, Bundall (AU)

(21) Appl. No.: 14/158,834

(22) Filed: Jan. 19, 2014

(51) Int. Cl. G06Q 30/02

(52) U.S. Cl. CPC G06Q 30/0243; G06Q 30/0269; G06Q 30/0255; G06Q 30/0261; G06Q 30/0252; G06Q 30/0258

(57) ABSTRACT

A method of generating qualified sales leads that enables sponsors to specify contests and/or surveys and qualifications for offers, enables prospects to enter contests and/or surveys and invite others to enter, and enables generation of qualified sales leads based on participation in the contests and/or surveys. The contests, surveys and offers or any combination thereof may be based on a current physical location of the participant or any combination of date, time, locality, temperature, altitude, speed, acceleration, and/or weather conditions Enables anonymously mining the database over multiple contests and/or surveys to determine life style ranges having a highest number of responses associated with a question or deployment type.

### BACKGROUND OF THE INVENTION

1. Field of the Invention

One or more embodiments of the invention are related to the field of data processing systems and communication systems. More particularly, but not by way of limitation, one or more embodiments of the invention enable a method of generating qualified sales leads that enables sponsors to specify contests and/or surveys and qualifications for offers, and enables current or past participants or new participants to participate in-contests and/or surveys and enter preferred contact methods and invite others to participate in the contests and/or surveys, and enables generation of qualified sales leads based on participation in the contests and/or surveys. In addition, contests and/or surveys and/or offers may be presented based on the participant's or potential sales lead's current physical location, and/or any combination of date, time, locality, temperature, altitude, speed, acceleration, weather conditions. Embodiments may also provide sponsors with optimized qualification questions and answer ranges to provide more efficient qualification through intelligent Internet searching and/or anonymous data mining from previous contests and/or surveys to determine qualification ranges that provide the best return on investment. Embodiments of the invention provide significant lead generation advantages and for example enable qualified users themselves to promote contests and/or surveys to broaden the exposure and generate even more qualified sales leads.

2. Description of the Related Art

Generally, lead generation is utilized by businesses to obtain sales leads and to thus provide sales and profits for the business. Obtaining sales leads is a critical step for organizations during their sales process in order to remain in business. Lead generation involves the identification of sales leads such as persons or business entities that may purchase a product or service. Sales leads may be qualified in a number of ways to generate sales prospects, or qualified sales leads. Qualified sales leads are in essence filtered sales leads that may actually purchase something according to the qualification criteria. There are many techniques currently utilized to generate qualified sales leads that involve direct marketing and advertising, however, current solutions for generating qualified sales leads are limited in their functionality for at least the reasons stated herein.

Lead generation may include obtaining information about clients or users based on their interests of products and/or services. For example, most lead generation techniques involve the use of marketing and advertising techniques that may be utilized with paid sources of information, such as advertisements, or free sources, such as word of mouth, referrals, recommendations, etc. Some solutions obtain sales leads from an array of sources including, but not limited to user activities online over the Internet, via telephone calls, and through analysis of other sources such as buyer purchases and telemarketing information.

After obtaining contact information and demographic information of particular users, for example, sales leads may be qualified using an array of ranges such as income, location, age, education, marital status, home ownership, etc. Once obtained, sales personnel typically contact the sales prospect, otherwise referred to herein as a potential consumer/user through phone calls, text messages, e-mails, postal mail and/or any other type of communications technology.

Once, obtained and qualified, the sales lead information may then be sold to one or more organizations. Sales leads that may be sold to multiple disparate companies for example are known as generic sales leads since they are not targeted initially at a specific product or service. Alternatively, marketing leads may be may be obtained using offers that are brand-specific, i.e., targeted towards generating leads for a specific company or brand, product and/or service for example. Marketing leads, however, generally involve a one-time fee for selling a specific product and/or service once.

Although free methods of lead generation exist, mostly using the Internet as a resource for creating viral videos, images, info-graphics, forums and the use of social media, typically, advertisers and/or sponsors pay for such lead generation. Typically, effective lead generation usually involves some type of payment to one or more marketing and sales companies to obtain contact information and demographic information of a user interested in one or more products and/or services. Payment for sales leads may be based on various pricing models set by lead generation companies. Usually, such pricing models vary by cost per mille, cost per click and cost per action. Current lead generation techniques, however, may charge advertisers for the number of ‘clicks’ applied by a user on an advertisement, charge advertisers regardless of the number of clicks, and charge advertisers for keyword searches, which typically become expensive as competition grows. With the increase in competition, for example, the costs per keyword have increased tremendously. Furthermore, when using the pay per action model, advertisers, typically, pay for specific leads that are a result of one or more actions being targeted, regardless of the number of ‘clicks’ per page, per advertisement, or search per keyword for example.

Currently, when using online lead generation, advertisers typically pay to receive a number of standard fields obtained by a website during a registration process, for example, or pay for page advertising where one or more offers and coupons presented by the advertiser may appear on the website's advertisement sections using specific texts and graphics. Other online lead generation techniques may include online surveys, where advertisers typically pay to purchase a particular set of information, or answers, as obtained from one or more users. Besides product advertising and/or service advertising, other industries that utilize lead generation vary from healthcare organizations and non-profit organizations in search for new patients, contacting existing patients and searching for potential donors.

However, with current methods, lead generation techniques remain expensive, and advertisers, usually, only obtain a small percentage of information related to consumers. In addition, using the current methods, advertisers may acquire information about unqualified sales leads, rather than focusing on targeting specific potential consumers and obtaining unique information for generating qualified sales leads. In addition, many companies provide only portions of the total solution, such as template generation for creating surveys, or contests, or the mechanism to contact sales leads, and do not provide optimized qualification questions or answer ranges or a combined solution.

For at least the limitations described above there is a need for a method of generating qualified sales leads.

### BRIEF SUMMARY OF THE INVENTION

One or more embodiments described in the specification are related to a method of generating qualified sales leads. In at least one embodiment of the invention, the method includes accepting a definition of a contest and/or survey from a sponsor, displaying life style questions to the sponsor that are to be utilized to qualify participants and accepting life style answers or qualification ranges from the sponsor. For example, a contest may involve a travel or holiday package or other item or service, wherein the contest includes a draw or selection in lottery fashion at a date in the future. Surveys may display and accept any type of information from the participants. In one or more embodiments of the invention, the life style questions may include information related to one or more of marital status, age and income, along with other optional sponsor questions that may be specific to and/or utilized by various sponsors.

Embodiments of the invention may include displaying the contest to a participant, accepting a participant response from the participant, which may for example include a ticket number associated with a draw as generated by the system for the participant, or a trivia input, guess or other input of any type, and contact information from the participant, along with preferred contact methods and/or media types, and storing the contact information from the participant in a database. Embodiments may also include displaying a survey and accepting a participant response that may include any type of input with respect to the survey. In one or more embodiments, a contest and a survey may be utilized to maximize the amount of information obtained as well as incentivize the participants to participate and also invite others to do so as well. The qualified participants may be utilized to generate qualified sales leads or qualified marketing leads. In one or more embodiments, the method may include requesting approval of the contest from an external server, for example, to obtain approval to run the contest due to government regulations, country-specific regulations, etc. In addition, specific approval for a specific participant to enter the contest may also be obtained based on government and location specific parameters as well as the current location of the participant, age of the participant, and/or any other restrictions placed on the participant from an external source. This enables the system to prevent users/participants that are unable or not allowed to enter the contest from entering. For example, if the participant is unable utilize the contest prize, offer and/or cash prize, approval of entry in the contest from an external server directly or indirectly associated with the participant may be obtained prior to allowing the participant entering the contest. Embodiments of the invention may be utilized to implement “Software as a Service” (SaaS) instances or standalone implementations or any other type of architecture as desired.

Furthermore, methods of embodiments of the invention may check the contest response against a contest answer, for example the drawn ticket number, trivia answer or value associated with a participant response and provide a prize to the participant if the participant response equals the contest answer. In addition to, or alternatively, the method in one or more embodiments may accept life style responses from the participant, and qualify the participant based on comparing the life style responses to the life style answers or answer ranges, characterize the participant as a qualified user if the life style response are within a predetermined range with respect to the life style answers, and provide an offer to the participant if the contest response does not equal the contest answer. In one or more embodiments, the offer may include one or more of a coupon and/or a discount on a service for example. Other embodiments may also provide the offer to the participant even if the participant has won the contest.

In at least one embodiment of the invention, the method may enable acceptance of another contest response from the participant if the participant refers a predetermined number of other participants to play the contest and if at least a second predetermined number of the other participants actually enter the contest and/or participate in the survey and enter their own contact information. Furthermore, embodiments of the invention may provide for personalizing of a website to appear to be from the sponsor regardless of the hosting location on the Internet. Embodiments may also analyze a Uniform Resource Locator or URL and determine if the participant is a first-time participant and if so, showing a generic welcome message and if not, showing a personalized welcome message.

By way of one or more embodiments of the invention, the method may include displaying a cash contest, different than the contest prize, to the participant, accepting a cash contest entry from the participant, and remotely checking the contest response against the contest answer using a draw server. The prize for the cash contest differs in the contest prize as the cash contest prize is awarded in rapid fashion in one or more embodiments and for example not at a later date associated with a draw. In addition, embodiments may include contacting the participant indicating whether the participant has won the cash content or has not won the cash contest, contacting the participant in either scenario, and if the participant has won, providing information to the participant on how to redeem the cash. Giving participants multiple ways to receive prizes, i.e., one long term and one short term in one manner in which embodiments of the invention increase participation and increase the generation of sales leads. Embodiments may also include displaying a survey to the participant as well as the two contests to maximize information obtained by the system.

In at least one embodiment of the invention, if the contest response does not equal the contest answer, an offer is provided to the participant, where the participant may accept the offer and/or the participant may send the offer to one or more other users, such as the participant's one or more friends, family, etc. For example, the method may include accepting the offer from the one or more other users and accepting a contest response from the one or more other users, such that the one or more other users are eligible for the respective coupon, discount on a service, or any other offer. In embodiments of the invention, when the participant has accepted the offer and/or the participant has sent the offer to one or more other users, the sponsor is alerted of such actions. Embodiments of the invention may display contest(s) and/or survey and in any particular time order as desired.

In at least one embodiment of the invention, the method may include generating an Online Customer List (OCL). For example, if the participant decides to enter the contest and is eligible for a prize, embodiments of the invention may accept a response from the participant to complete a prize entry form, and one or more of accept prize entry form information from the participant and, in addition or alternatively to, automatically enter prize entry form information about the participant from at least one of the stored contact information and accepted life style question responses from the participant. As such, either the participant enters his/her own information to the prize entry form, or automatically entering information about the participant to the prize entry form from the participant's contact information, life style responses, and/or any other information that may have been previously stored in the database. In one or more embodiments, the method may verify the entry form, verify any participant referrals to any number of other participants, such as the predetermined number of other participants, and save the contest to the Online Customer List (OCL). When saved to the OCL, for example, embodiments may include one or more of assigning a number to the participant in the OCL and displaying the prize information and the assigned number to the participant. The OCL may be sold or otherwise utilized at a fee by external entities as qualified leads for marketing.

By way of one or more embodiments of the invention, the method may include accepting a response from the participant to complete a prize entry form, as discussed above, and in addition, accepting an indication from the participant to refer one or more other participants to play the contest. When an indication of one or more other participants referrals is accepted, embodiments may display a social invite plug-in to the participant, such that the participant selects one or more other participant contacts, and the method may include sending an invitation to the selected one or more other participants to participate in the contest, for example using an email contact plugin for a browser.

In one or more embodiments of the invention, the method may accept a single or multiple campaigns from the sponsor, or multiple sponsors, where each campaign may include one or more of at least one contest, at least one prize, at least one offer, and optionally include at least one cash contest. For example, embodiments may accept a single campaign that may include multiple contests and/or surveys, or accept multiple campaigns, each with a single contest or multiple contests and/or surveys. In at least one embodiment, the method may include anonymously mining the database over the plurality of the contests and/or surveys, to determine life style ranges that may have a highest number of responses associated with a particular life style question. For example, embodiments may anonymously look at various respondent non-identifying data fields without identifying a particular person for different ranges, from the life style questions from a single sponsor, or multiple sponsors, in order to notify the sponsor(s) of the list of age ranges, for example, martial status ranges, and/or income ranges that have the highest number of responses to the particular life style questions. This enables sponsors to opt in for anonymous use of non-identifying user information in order to obtain better results and help improve the system and to have the added security that their data will not be utilized for any other purpose than optimization. As such, for example, the system enables the sponsor(s) to utilize a specific age range, marital status and/or income range that would be most beneficial in generating and then contacting any qualified sales leads. Alternatively or in combination, intelligent web page scraping or other Internet searching may be utilized alone or in combination with the anonymous database mining to look for demographic ranges and other life style answer ranges for use in targeting particular users that may result in the best return on investment. These targeted qualified sales leads may be sold for a premium in one or more embodiments.

By way of one or more embodiments, the method may include displaying a list of best qualifying ranges associated with the highest number of responses over the plurality of contests and/or surveys to the sponsor, and/or displaying a list of best qualifying ranges associated with the highest number of responses specific to a deployment type over the multiple campaigns, to the sponsor. In at least one embodiment of the invention, the deployment type may include one or more of e-mail, SMS Text Messages, or any combination thereof. For example, displaying the list of best qualifying ranges associated with the highest number of responses may depend on whether the highest number of responses were obtained via e-mail and/or SMS Text Messages, for example, such that the sponsor may be notified of the specific deployment platform that outputs the highest number of responses, in order to enable the sponsor to utilize the specific deployment type platform that would be most beneficial in contacting any sales leads. Providing sponsors with best performing life styles questions and answers/ranges and best performing deployment types such as email, social media, online promotions, magazine ads, newspaper ads, banner ads, direct mail, newsletters, SMS Text Messaging, trade show promotions, shopping center promotions, bill messages, radio commercials, etc., and based on previous campaigns and/or Internet searching to maximize the number of qualified sales leads is unknown in the art.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an architectural view of at least one embodiment of the system configured to implement the method of generating qualified sales leads.

FIG. 2 illustrates a flow chart for the main functional elements of the method.

FIG. 3 illustrates a flow chart for the main process of setting up and operating a contest.

FIG. 4 illustrates a flow chart for the main process of setting up an optimized contest.

FIG. 5 illustrates a flow chart detailing the generation of an Online Customer List (OCL) and accepting of a contest response and referrals from a participant.

FIG. 6 illustrates tables detailing the display of results and reports associated with life style ranges indexed by deployment type across multiple campaigns.

FIG. 7 illustrates an example contest website.

FIG. 8 illustrates example lifestyle questions utilized in qualifying a participant for offers.

FIG. 9 illustrates an embodiment that provides offers and/or contests and/or surveys based on a participant's or potential sales lead's current physical location, and/or any combination of date, time, locality, temperature, altitude, speed, acceleration, and/or weather conditions.

### DETAILED DESCRIPTION OF THE INVENTION

A method of generating qualified sales leads will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

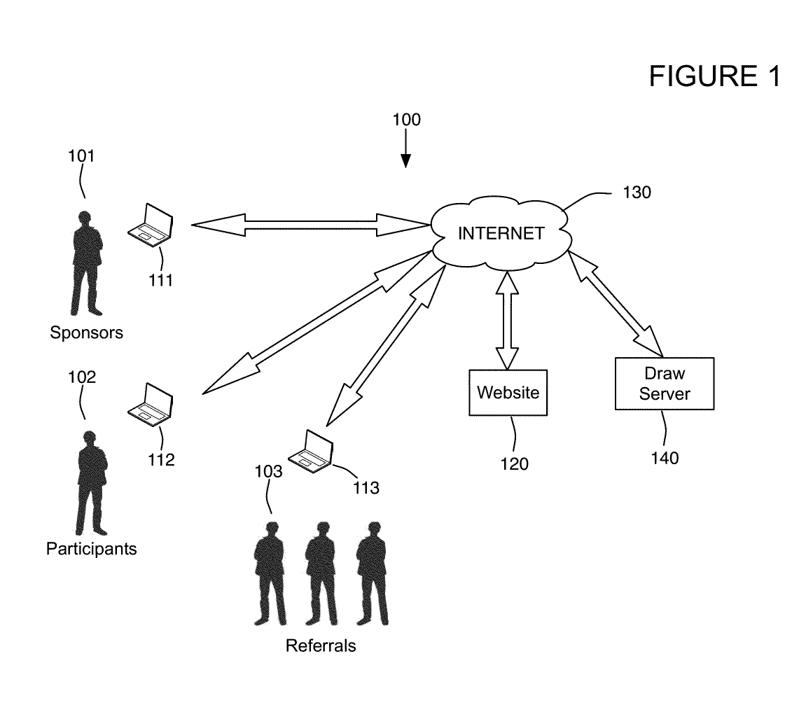

FIG. 1 illustrates an architectural view of at least one embodiment of the system configured to implement the method of generating qualified sales leads. One or more embodiments of the invention enable a method of generating qualified sales leads that enables sponsors 101 to specify contests and/or surveys and qualifications for offers, enables current or past customers or new prospects to enter contests and/or surveys and invite others to enter the contests and/or surveys, and enables generation of qualified sales leads based on participation in the contests and/or surveys. As shown in FIG. 1, the system 100 may include one or more sponsors 101 that may specify contests and/or surveys and/or offers, one or more communication devices 111 used by the one or more sponsors 101, one or more participants 102 that may participate in the contest, one or more communication devices 112 used by the one or more and one or more participants, referrals 103 as referred to by the one or more participants 102, and one or more communication devices 113 used by the one or more referrals 103. Using the respective communication devices, 111, 112 and 113, the one or more sponsors 101, participants 102 and referrals 103 may bidirectionally communicate with a website 120 and/or draw server 140 via the Internet 130. Website 120 may be utilized to implement Software as a Service (SaaS) or embodiments of the system may be sold and implemented as standalone instances on Website 120 or any combination thereof, or using any other business architecture. Embodiments may include online payment systems coupled with Website 120 for example to accept payment for use of the system. Embodiments of the system may be “white labeled” to appear to be hosted in any domain and specific to a particular sponsor regardless of the hosting location of Website 120.

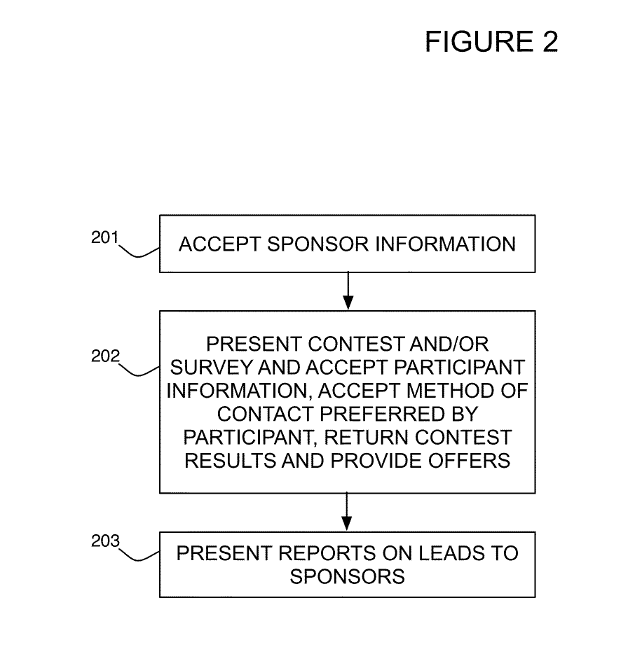

FIG. 2 illustrates a flow chart for the main functional elements of the method. As shown in FIG. 2, the system 100 may accept sponsor information 201 from the one or more sponsors 101. At 202, the system may present the contest to the one or more participants 102, accept contest information from the one or more participants 102 along with method of contact including SMS, phone, email, social media site, and/or physical location, etc., as preferred by the participant, and return contest results and provide one or more offers to the one or more participants 102. Therefrom, the system may present one or more reports on sales leads to the one or more sponsors 101. These high level methods are described in detail with respect to the remainder of the figures. For example, if the participant is currently at a physical location, or within a defined region, then the contest may be made available to the participant and/or offers may be sent for products/services and/or surveys that take local information into account, i.e., that include questions related to things that are near the current physical location of the participant. This enables a location appropriate offer to be sent to the participant, for example if the participant is in a particular country and/or near a particular store associated with the campaign and/or contest. This enables embodiments of the invention to intelligently target offers to participants based on their current physical location, as well as time and weather and other parameters described in more detail below and improves the viral offers sent from participants to other potential referrals to optimize the lead generation process based on location.

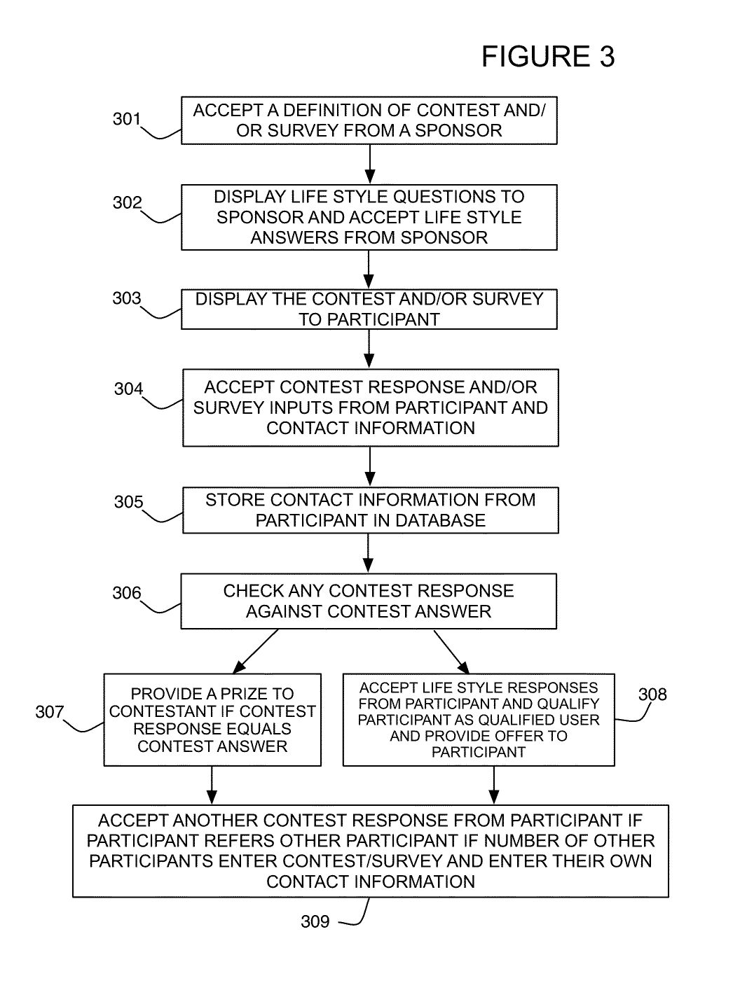

FIG. 3 illustrates a flow chart for the main process of setting up a contest and/or survey. As shown in FIG. 2, in at least one embodiment of the invention, the method includes at 301 accepting a definition of a contest and/or survey from a sponsor, of the one or more sponsors 101, displaying life style questions to the one or more sponsors 101 that are to be utilized to qualify participants and accepting life style answers or qualification ranges from the one or more sponsors 101, at 302. The method at 301 may also include setting up one or more campaigns that may include a start and stop date, associated contest and/or survey or competition and deployment types, e.g., email, SMS, physical mail, phone, social media site or any other type of contact methodology.

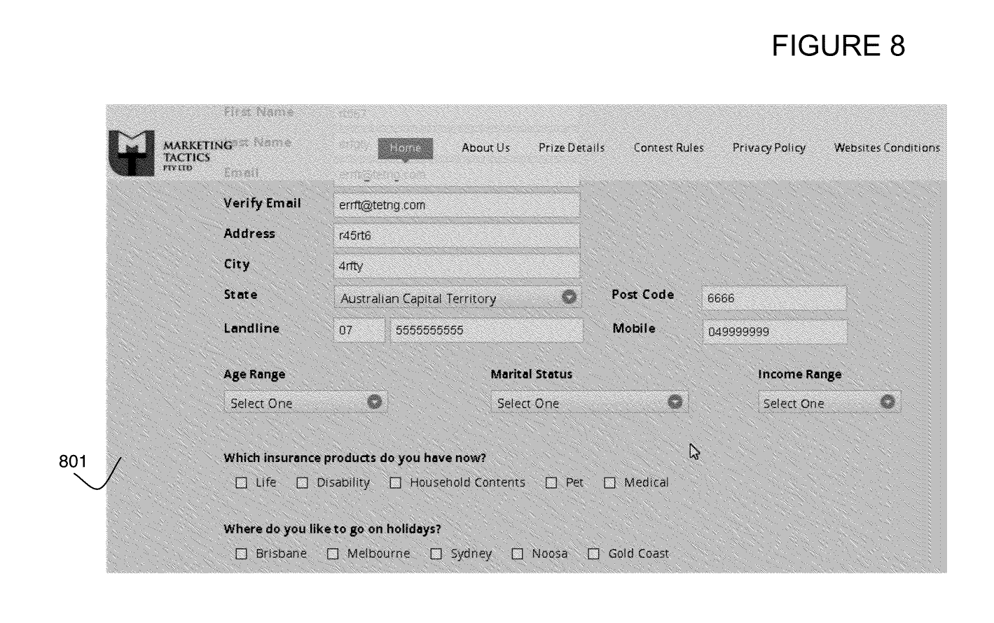

For example, a contest may involve a travel or holiday package or other item or service, wherein the contest includes a draw or selection in lottery fashion at a date in the future. In one or more embodiments of the invention, the life style questions may include information related to one or more of marital status, age and income, see also FIG. 8. An example survey question also appears at the bottom of FIG. 8. At 303, embodiments of the invention may include displaying the contest and/or survey to a participant, of the one or more participants 102, and at 304 accepting a participant response, e.g., contest response and/or survey answers from the one or more participants 102 and contact information from the participant. In addition, at 305, the method may include storing the contact information as well as any other inputs such as contest answers and/or survey answers from the participant in a database coupled with a computer for example that hosts website 120 or any other computer coupled with Internet 130 as one skilled in the art will appreciate.

Qualified participants, of the one or more participants 102, may be utilized to generate qualified marketing leads. In one or more embodiments, the method may include requesting approval of the contest from an external server, for example, to obtain approval to run the contest due to government regulations, country-specific regulations, etc. In addition, specific approval for a specific participant to enter the contest may also be obtained based on government and location specific parameters as well as the current location of the participant, age of the participant, and/or any other restrictions placed on the participant from an external source. This enables the system to prevent users/participants, of the one or more participants 102 that are unable or not allowed to enter the contest from entering it. For example, if the participant 102 is unable utilize the contest prize, offer and/or cash prize, approval of entry in the contest from an external server directly or indirectly associated with the participant may be obtained prior to allowing the participant entering the contest.

Furthermore, as shown at step 306, methods of embodiments of the invention may check the contest response against a contest answer, for example the drawn ticket number, trivia answer or value associated with a participant response and at 307 provide a prize to the participant 102 if the participant 102 response equals the contest answer. In addition to, or alternatively, the method in one or more embodiments, at step 308, may accept life style responses from the participant 102, and qualify the participant 102 based on comparing the life style responses to the life style answers or answer ranges, characterize the participant as a qualified user if the life style response are within a predetermined range with respect to the life style answers, and provide an offer to the participant if the contest response does not equal the contest answer. In one or more embodiments, the offer may include one or more of a coupon and/or a discount on a service for example. Other embodiments may also provide the offer to the participant even if the participant has won the contest.

In at least one embodiment of the invention, the method may enable acceptance of another contest response from the participant 102 if the participant 102 refers a predetermined number of other participants, such as referrals 103, to play the contest and if at least a second predetermined number of the other participants 103 actually enter the contest and enter their own contact information, as shown at step 309. Embodiments may display a different survey to the participant on second entry or bypass the survey and enable the participant to enter the contest again as configured into the particular implementation. Furthermore, embodiments of the invention may provide for personalizing of a website, such as website 120, to appear to be from the sponsor 101, of the one or more sponsors, regardless of the hosting location on the Internet 130. Embodiments may also analyze a Uniform Resource Locator or URL and determine if the participant is a first-time participant and if so, showing a generic welcome message and if not, showing a personalized welcome message.

By way of one or more embodiments of the invention, the method may include displaying a cash contest, different than the contest prize, to the participant 102, accepting a cash contest entry from the participant 102, and remotely checking the contest response against the contest answer using the draw server 140. The prize for the cash contest differs in the contest prize as the cash contest prize is awarded in rapid fashion in one or more embodiments. In addition, embodiments may include contacting the participant 102 indicating whether the participant has won the cash content or has not won the cash contest, contacting the participant 102 in either scenario, and if the participant has won, providing information to the participant 102 on how to redeem the cash. Giving participants multiple ways to receive prizes, i.e., one long term and one short term in one manner in which embodiments of the invention increase participation and increase the generation of sales leads. If a participant also enters information for a survey, the first and second prize values may be set at different levels to incentivize the participant to enter the survey if desired.

In at least one embodiment of the invention, if the contest response does not equal the contest answer, an offer is provided to the participant 102, where the participant may accept the offer and/or the participant 102 may send the offer to one or more other users, such as referrals 103, such as the participant's 102 one or more friends, family, etc. For example, the method may include accepting the offer from the one or more other users, 103, and accepting a contest response from the one or more other users 103, such that the one or more other users 103 are eligible for the respective coupon, discount on a service, or any other offer. In embodiments of the invention, when the participant 102 has accepted the offer and/or the participant has sent the offer to one or more other users 103, the sponsor 101 is alerted of such actions.

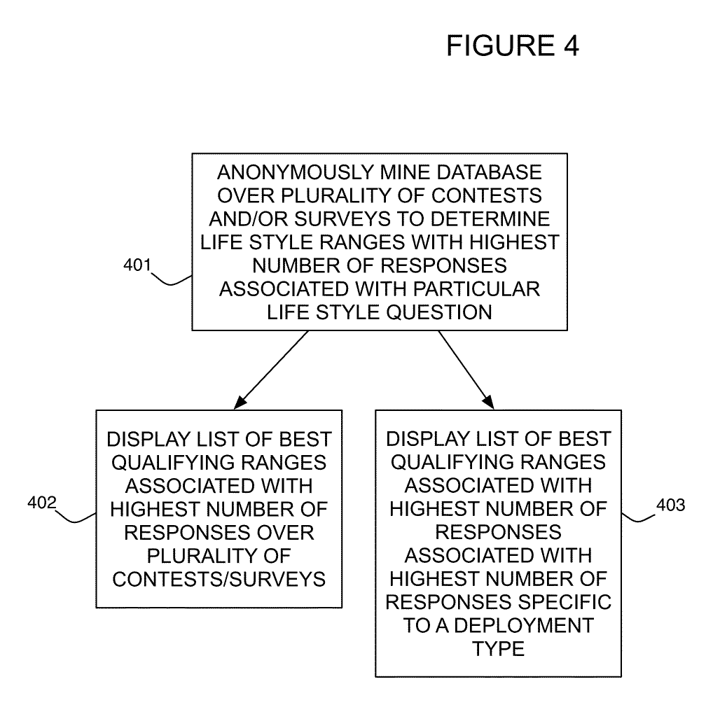

FIG. 4 illustrates a flow chart for the main process of setting up an optimized contest. In one or more embodiments of the invention, the method may accept a single or multiple, campaigns from the sponsor 101, for example who has opted in for anonymous use of data without identifying information related to any users, or multiple sponsors 101, where each campaign may include one or more of at least one contest, at least one prize, at least one offer, and optionally include at least one cash contest. For example, embodiments may accept a single campaign that may include multiple contests and/or surveys, or accept multiple campaigns, each with a single contest or multiple contests and/or surveys. As shown in FIG. 4, at 401, in at least one embodiment, the method may include anonymously mining the database over the plurality of the contests and/or surveys, to determine life style ranges that may have a highest number of responses associated with a particular life style question. For example, embodiments may look at various respondent numbers for different ranges, from the life style questions from a single sponsor 101, or multiple sponsors 101, in order to notify the sponsor(s) 101 of the list of age ranges, for example, martial status ranges, and/or income ranges that have the highest number of responses to the particular life style questions. As such, for example, the system enables the sponsor(s) to utilize a specific age range, marital status and/or income range that would be most beneficial in generating and then contacting any qualified sales leads. Alternatively or in combination, embodiments of the invention may also utilize any computer shown in FIG. 1 for example to search Internet 130 for similar information, for example by scraping pages for response frequency for age ranges, marital status or income or any other demographic factors and target people from those ranges in generating ranges for use by sponsors in building the life style questions.

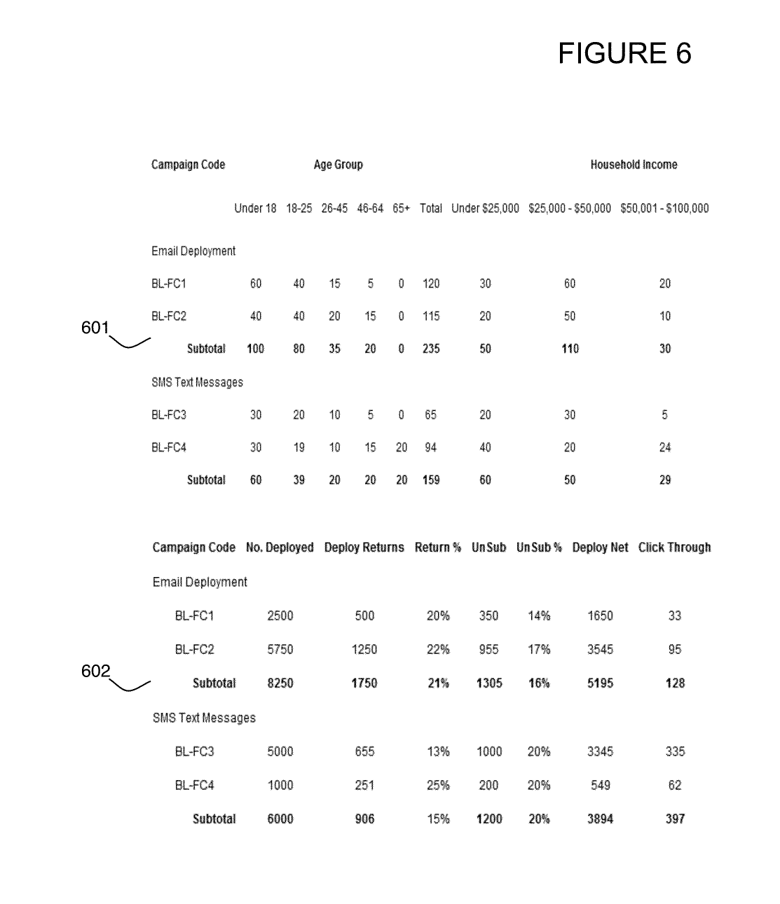

By way of one or more embodiments, at 402, the method may include displaying a list of best qualifying ranges associated with the highest number of responses over the plurality of contests and/or surveys to the sponsor 101, and/or at step 403, displaying a list of best qualifying ranges associated with the highest number of responses specific to a deployment type over the multiple campaigns, to the sponsor 101. In at least one embodiment of the invention, the deployment type may include one or more of e-mail, SMS Text Messages, or any combination thereof. For example, displaying the list of best qualifying ranges associated with the highest number of responses may depend on whether the highest number of responses were obtained via e-mail and/or SMS Text Messages, for example, such that the sponsor 101 may be notified of the specific deployment platform that outputs the highest number of responses, in order to enable the sponsor 101 to utilize the specific deployment type platform that would be most beneficial in contacting any sales leads. Providing sponsors 101 with best performing life styles questions and answers/ranges and deployment types such as email, SMS, etc., as will be discussed further in the detailed description of FIG. 6, and based on previous campaigns to maximize the number of qualified sales leads is unknown in the art. Using the life style questions, the system 100 may determine if a participant 102, or referral 103, is qualified to receive the offer. For example, by determining a salary range, a location range, the type of household (whether the one or more participants 102 own/rent an apartment, townhouse, single family home etc) and the various salary ranges, the system 100 may figure out a number of respondents for each type of campaign and type of life style question in determine the highest number of responses from the plurality of contests and/or surveys. As such, if the highest number of responses, for example, are associated with SMS texting, the one or more sponsors 101 are notified of such ranges to enable the one or more sponsors 101 to determine the most qualified leads and deployment type for contacting the qualified leads.

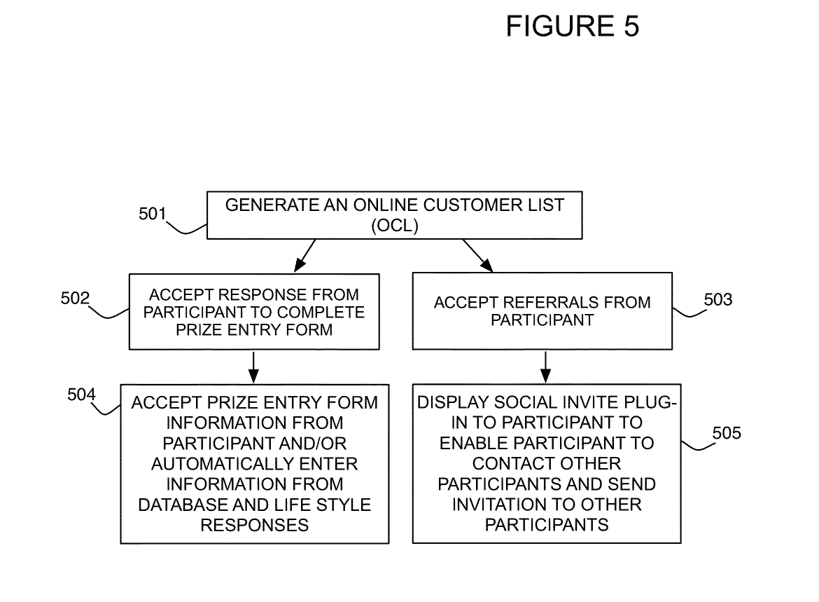

FIG. 5 illustrates a flow chart detailing the generation of an Online Customer List (OCL) and accepting of a contest response and referrals from a participant. As shown in FIG. 5, in at least one embodiment of the invention, the method may include generating an Online Customer List (OCL) at 501. For example, if the participant decides to enter the contest and is eligible for a prize, embodiments of the invention may accept a response from the participant to complete a prize entry form at 502. At 504, the method may accept prize entry form information from the participant 102 and, in addition or alternatively to, automatically enter prize entry form information about the participant 102 from at least one of the stored contact information and accepted life style question responses from the participant. As such, either the participant 102 enters his/her own information to the prize entry form, or automatically entering information about the participant 102 to the prize entry form from the participant's contact information, life style responses, and/or any other information that may have been previously stored in the database, verify the entry form. In one or more embodiments, as shown at 503, if the one or more participants 102 provides one or more referrals 103, the method may accept referrals from the participant 102, verify any participant referrals to any number of other participants, such as the predetermined number of other participants, and save the contest to the Online Customer List (OCL). When saved to the OCL, for example, embodiments may include one or more of assigning a number to the participant 102 in the OCL and displaying the prize information and the assigned number to the participant 102. The OCL may be sold or otherwise utilized at a fee by external entities as qualified leads for marketing.

By way of one or more embodiments of the invention, the method may include accepting a response from the participant to complete a prize entry form, as discussed above, and accept an indication from the participant 102 to refer one or more other participants 103 to play the contest. As shown at 505, when an indication of one or more other participants referrals 103 is accepted, embodiments may display a social invite plug-in to the participant 102, such that the participant 102 may select one or more other participant contacts, and the method may include sending an invitation to the selected one or more other participants 103 to participate in the contest.

FIG. 6 illustrates tables detailing the display of results and reports associated life style ranges indexed by deployment type across multiple campaigns. Although not limited to the reports shown, element 601 shows an example of a campaign activity, as the one or more sponsors 101 have initially set up. For example, the one or more sponsors 101 may set up a campaign for each media source, and set up a name, description and campaign code for each campaign. For example, as shown in 601, the displayed report is categorized by deployment type, such as Email deployment, SMS Text Messages deployment, etc., and by each life style question/response, such as age group, household income, marital status, etc. In at least one or more embodiments, the system 100 may automatically update each campaign during one or more participant 102 and/or referrals 103 activity. As such, in one or more embodiments, sponsors 101 may track the number of answers to each life style questions, as will be discussed in FIG. 8 below, to manage the qualifying process of determining qualified sales leads.

Element 602, in at least one embodiment, shows an example of a displayed report as categorized by deployment type, such as Email deployment, SMS Text Messages deployment, etc., and by the number of responses for a specific deployment, the number of deploy returns, the percentage of returns, the number of ‘unsubscribers’, the percentage of ‘unsubcribers’, etc. As such, for example, in at least one embodiment, the one or more sponsors 101 may track any email bounce backs and unsubscribe alerts.

In addition to the above example reports, by way of one or more embodiments, the system may also display reports on unsubscribe lists, offer alerts, contact alerts, lead lists, contest registrants lists, referral lists, email offer lists, and non-qualified lists. For example, a report of unsubscribe lists displays any unsubscribe or opt-our requests that may have resulted from one or more deployments, such as Email or SMS Text Messages, displaying the email addresses and/or contact numbers of the one or more participants 102 or referrals 103 that have requested to be removed from the database. Offer alerts lists, for example, may display the number of participants 102 or referrals 103 that have selected an offer, of one or more offers and which offers of the one or more offers that have a highest number of selections. As such, in at least one embodiment, the one or more sponsors 101 may identify one or more campaigns with a higher than usual offer alert rate that enable the one or more sponsors 101 to amend any number of offers listed. As such, for example, the one or more sponsors 103 may be able to contact any participants 102 or referrals 103 that have not selected one or more offers to increase the number of qualified sales leads. For example, a contact alerts list, in one or more embodiments of the invention, displays a list of contacts and potential new sales leads, as a sales leads list. In addition, the system 100 may display a contest registrants list and referrals list to enable the one or more sponsors 101 to obtain details of any registrants that have registered for the contest, and details of referrals 103 that were referred by a participant 102, such that the participants 102 that have provided the referrals 103, as discussed above, may be awarded.

In addition, or alternatively to, in one or more embodiments of the invention, the system 100 may display an email offer list, such that the one or more participants 102 and/or referrals 103 may obtain the selected one or more offers via e-mail, as well as display the participants 102 and/or referrals 103 contact information for future follow up after receipt of the one or more offers. In at least one embodiment, the system 100 may display a non-qualified lead list detailing information about the participants 102 that have not met any qualifications as determined by the life style questions and responses, which will be discussed below regarding FIG. 8.

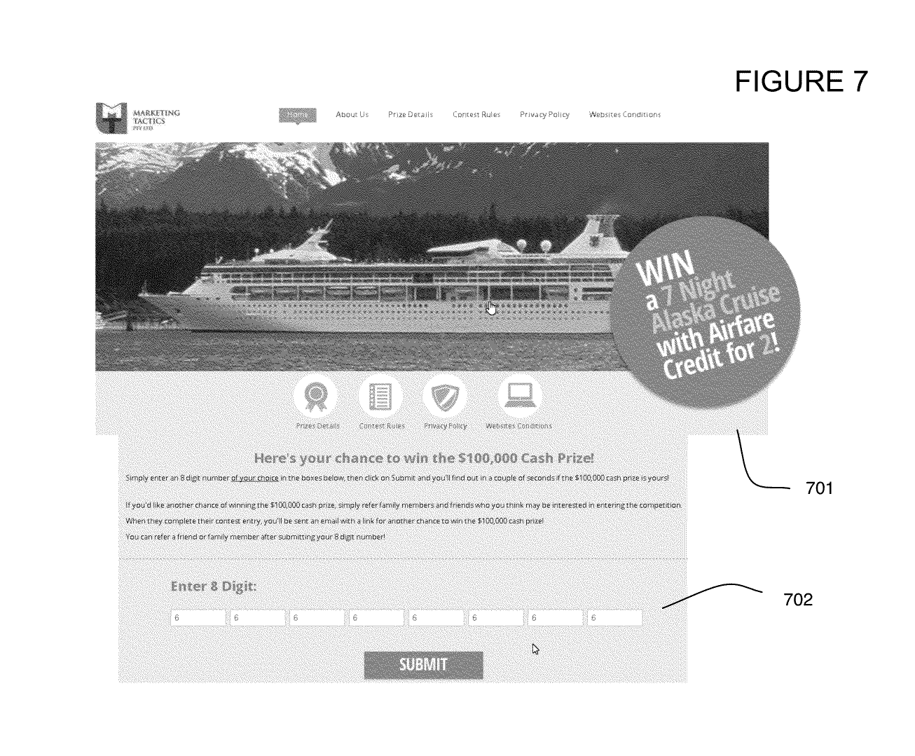

FIG. 7 illustrates an example contest website. As shown at 701, the example contest website displays the contest that may involve a travel or holiday package or other item or service, wherein the contest includes a draw or selection in lottery fashion at a date in the future. From the example contest website 701, the one or more potential participants 102, or referrals 103, may view any prize details, contest rules, privacy policy, etc. The website may also present a cash contest for immediate results and improve response rates by participants at 702. By entering a multi-digit code for example, the participant may instantly win a cash prize. This for example enables embodiments of the invention to achieve increased referral rates by providing extra incentive to participants to refer their friends, family and other acquaintances.

FIG. 8 illustrates example lifestyle questions utilized in qualifying a participant for offers. In one or more embodiments of the invention, the life style questions may include information related to one or more of marital status, age and income. As shown in FIG. 8, element 801 is an illustration example of the contest entry form on the website. As depicted, in at least one embodiment of the invention, the life style questions are part of the entry form, allowing the one or more participants 102 and/or referrals 103 to qualify for one or more offers, by entering contact information and responses to the one or more life style questions. As shown at 801, by way of one or more embodiments of the invention, the one or more life style questions may include age range, marital status, income range, and unique questions as specified by the one or more sponsors 101. The unique questions, for example, in one or more embodiments of the invention, may include one or more of “Which insurance products do you have now?” and “Where do you like to go on holiday?”. These types of questions may be considered a survey in one or more embodiments, or any other type of question may be utilized with any type of interface to implement a survey in one or more embodiments of the invention. It is noted, however, as one of ordinary skill in the art will appreciate, that any other unique questions may be displayed as chosen by the one or more sponsors 101. According to one or more embodiments of the invention, in answering the questions as presented in the entry form, shown at 801, the system may determine if the one or more participants 102 and/or referrals 103 are qualified to receive the one or more offers and prizes, and where the interests of the one or more participants 102 and/or referrals 103 lay regarding one or more of the sponsor's 101 products and/or services. As such, only qualified participants and/or referrals are directed to the one or more sponsor's 101 offers page and prize page.

By way of one or more embodiments of the invention, the system may accept life style answers from the one or more sponsors 101, such that the one or more sponsors 101 may input, for example, the specific age range, marital status and household income ranges they are looking for, as well as answers to the one or more unique life style questions also presented on the entry form, that would qualify the one or more participants 102 and/or referrals 103 to the one or more offers and prizes. In at least one or more embodiments, the system may accept one or more changes to the preferred answered for age range, marital status, household income, and to the unique life style questions at any time from the one or more sponsors 101, in order to gain the most qualified sales leads that may be interested in the one or more products and/or services.

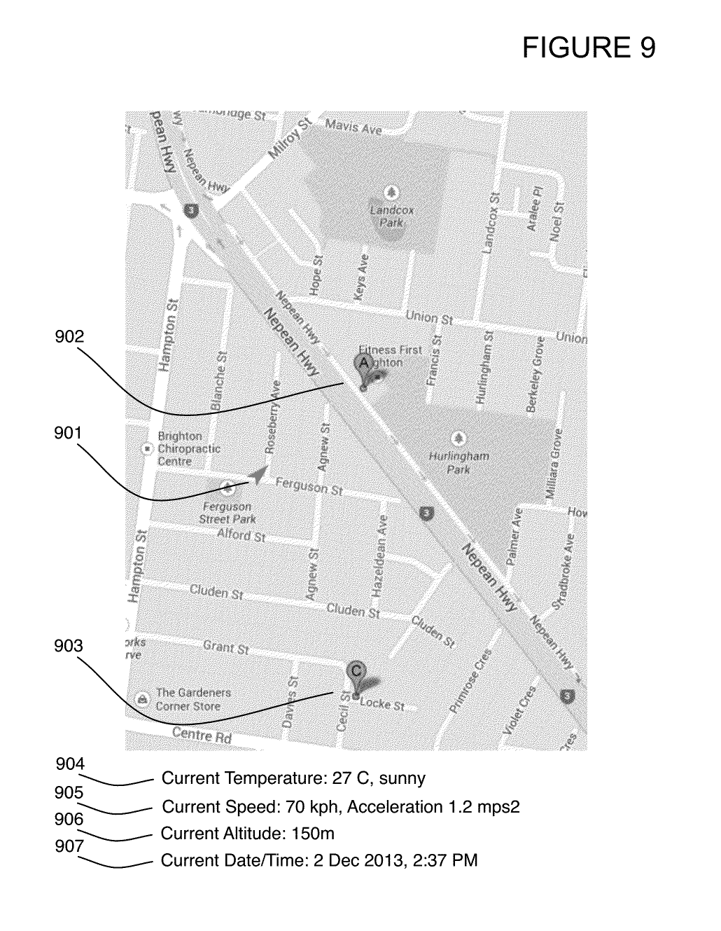

FIG. 9 illustrates an embodiment that provides offers and/or contests and/or surveys based on a participant's or potential sales lead's current physical location, and/or any combination of date, time, locality, temperature, altitude, speed, acceleration, and/or weather conditions. As shown, the user's current location is shown on the map at 901. As there may be multiple offers, for example coupons for services and/or products for a given or disparate entity shown at locations 902 and 903, the system may determine which offer to provide based on the distance to each entity at 902 and/or 903. In addition, if the offer provided by entity at 902 is related to temperature and the temperature is at, above or below a particular threshold, as obtained from an external weather server for the user's current location or from the user's electronic device for example, as shown at 904, then an offer may be provided based on the temperature and/or weather condition 904. In addition, survey questions may be provided based on current physical location, and/or any combination of date, time, locality, temperature, altitude, speed, acceleration, and/or weather conditions as well. This enables the system to display a survey question such as the amount of time in the sun that the user typical spends so that sponsors associated with particular products may obtain information that may help manufactures sell that product for example. For example an offer for sunglasses and sunscreen may be provide by either entity 902 or 903 and offered for example based on the user's current location 901 and/or in combination with an answer to a survey question that indicates that the offer may be appropriate. Alternatively, if the offers provided at 902 and 903 are for competing products, then the system may utilize the user's current physical location and/or time of travel to entity locations 902 and 903 to determine which offer to present to the user. In addition, the user's current speed and/or acceleration 905 as for example derived from the user's mobile phone or other electronic device may be utilized to provide an offer, for example if the user's speed is within a particular range which would be indicative of running, then the user may be provided an offer for running shoes. If the user is over a particular speed limit at the location, then the user may be provided an offer for driving school or ticket legal services. If the acceleration is indicative of high acceleration, for example as indicative of motorcycle riding, then the user may be provided an offer of a motorcycle related service or product, e.g., helmet or riding jacket discount. In addition, if the user's acceleration and/or speed is over a particular level, then the system may delay providing information, for example until the user stops driving. If the user's current altitude 906 is at or within a predefined range, the user may be provided with particular offers related to skiing, mountain climbing, or beach wear indicative of activities that occur at that elevation for example. If the date 907 is for example a Monday as derived from a current date/time, then the user may be provided with particular offers that are offered on that day of the week or after a particular time or on a particular holiday indicated by the date for example. In addition to providing offers based on these parameters and/or the user's current physical location, the system may also present contests and/or surveys based on these parameters as well. For example, if the temperature is cold, then a contest to the Caribbean, where the temperature is currently warm may be provided to induce interest and further participation in the contest for example.

While the invention herein disclosed has been described by means of specific embodiments and applications thereof, numerous modifications and variations could be made thereto by those skilled in the art without departing from the scope of the invention set forth in the claims.

1. A method of generating qualified sales leads using a computer comprising:
requesting approval of one or more of a contest and a survey from an external server to obtain approval to run the contest or the survey or both the contest and the survey;
requesting approval for a participant to enter the contest based on government and location parameters, and one or more of current location of the participant, age of the participant and restrictions placed on the participant from said external server;
accepting a definition of said contest or survey or both contest and survey from a sponsor after said requesting approval;
displaying life style questions to the sponsor;
wherein the life style questions comprise information related to one or more of marital status, age and income;
accepting life style answers or answer ranges from the sponsor;
displaying the contest or survey or both contest and survey to a participant;
accepting a first contest response or survey response or both from the participant and contact information from the participant;
storing one or more of said first contest response, said survey response and said contact information from the participant in a database coupled with said computer;
accepting the first contest response, and when the first contest response is accepted, checking the first contest response against a contest answer and providing a prize to the participant when the first contest response equals the contest answer;
accepting life style responses from the participant and,
qualifying the participant based on comparing the life style responses to the life style answers or answer ranges and characterizing the participant as a qualified user when the life style responses are within a predetermined range with respect to the life style answers and,
providing an offer to the participant when the first contest response does not equal the contest answer or when the participant has entered said survey response;
accepting the participant referring a predetermined number of other participants to enter the contest or participate in the survey; and,
enabling acceptance of another contest response from the participant in addition to the first contest response when the participant refers a predetermined number of other participants to enter the contest or participate in the survey and when at least a second predetermined number of the other participants actually enter the contest or survey or both and enter their own contact information.

2. The method of generating qualified sales leads using a computer of claim 1, further comprising analyzing a Uniform Resource Locator or URL and determining if the participant is a first-time participant and if not, showing a personalized welcome message.

3. The method of generating qualified sales leads using a computer of claim 1, further comprising displaying a cash contest to the participant and accepting a cash contest entry from the participant and remotely checking the first contest response against the contest answer using a draw server and contacting the participant indicating whether the participant has won the cash content or has not won the cash contest.

4. The method of generating qualified sales leads using a computer of claim 1 wherein said contest or survey or offer or any combination thereof are based on an acceleration associated with the participant.

5. The method of generating qualified sales leads using a computer of claim 1, further comprising accepting the offer from the participant and enabling the participant to send the offer to one or more other users.

6. The method of generating qualified sales leads using a computer of claim 5, further comprising alerting the sponsor of the offer, the participant's acceptance of the offer and the one or more other users receiving the offer.

7. The method of generating qualified sales leads using a computer of claim 5, wherein said contest or survey or offer or any combination thereof are based on a current physical location of the participant.

8. The method of generating qualified sales leads using a computer of claim 7, wherein said contest or survey or offer or any combination thereof are based on a current temperature or weather conditions or altitude or date or time associated with the current physical location of the participant.

9. The method of generating qualified sales leads using a computer of claim 1, wherein said contest or survey or offer or any combination thereof are based on one or more of a current speed and acceleration associated with the participant.

10. (canceled)

11. The method of generating qualified sales leads using a computer of claim 1, wherein the offer comprises one or more of a coupon and a discount on a service.

12. The method of generating qualified sales leads using a computer of claim 1, further comprising generating an Online Customer List (OCL).

13. The method of generating qualified sales leads using a computer of claim 12, further comprising accepting a response from the participant to complete a prize entry form and one or more of accepting prize entry form information from the participant and automatically entering prize entry form information about the participant from at least one of the stored contact information and accepted life style question responses from the participant.

14. The method of generating qualified sales leads using a computer of claim 13, further comprising verifying the entry form, verifying the participant referral to the predetermined number of other participants, and saving the participant to the OCL.

15. The method of generating qualified sales leads using a computer of claim 14, further comprising assigning a number to the participant in the OCL.

16. The method of generating qualified sales leads using a computer of claim 15, further comprising displaying the prize information and the assigned number to the participant.

17. The method of generating qualified sales leads using a computer of claim 1, further comprising accepting a response from the participant to complete a prize entry form and accepting an indication from the participant to refer one or more other participants to enter the contest or survey or both.

18. The method of generating qualified sales leads using a computer of claim 17, further comprising displaying a social invite plug-in to the participant, such that the participant selects one or more other participant contacts, and sending an invitation to the selected one or more other participants to participate in the contest or survey or both.

19. The method of generating qualified sales leads using a computer of claim 1, wherein said database holds information related to a plurality of contests or surveys or both, and further comprising anonymously mining said database over the plurality of the contests and/or surveys to determine life style ranges having a highest number of responses associated with a particular life style question of said life style questions.

20. The method of generating qualified sales leads using a computer of claim 19, further comprising displaying a list of best qualifying ranges associated with the highest number of responses over the plurality of contests or surveys or both to the sponsor.

21. The method of generating qualified sales leads using a computer of claim 19, further comprising
accepting multiple campaigns from the sponsor;
wherein each campaign of the multiple campaigns respectively comprises one or more of a contest, a prize and an offer; and,
displaying a list of best qualifying ranges associated with the highest number of responses specific to a deployment type over the multiple campaigns;
wherein said deployment type comprises one or more of at least email and SMS Text Messages.

22. A method of generating qualified sales leads using a computer comprising:
requesting approval of one or more of a contest and a survey from an external server to obtain approval to run the contest or the survey or both the contest and the survey;
requesting approval for a participant to enter the contest based on government and location parameters, and one or more of current location of the participant, age of the participant and restrictions placed on the participant from said external server;
accepting a definition of said contest or survey or both contest and survey from a sponsor after said requesting approval;
displaying life style questions to the sponsor;
wherein the life style questions comprise information related to one or more of marital status, age and income;
accepting life style answers or answer ranges from the sponsor;
displaying the contest or survey or both contest and survey to a participant;
accepting a first contest response or survey response or both from the participant and contact information from the participant;
storing one or more of said first contest response, said survey response and said contact information from the participant in a database coupled with said computer, wherein said database holds information related to a plurality of contests and/or surveys;
accepting the first contest response, and when the first contest response is accepted, checking the first contest response against a contest answer and providing a prize to the participant when the first contest response equals the contest answer;
accepting life style responses from the participant and,
qualifying the participant based on comparing the life style responses to the life style answers or answer ranges and characterizing the participant as a qualified user when the life style responses are within a predetermined range with respect to the life style answers and,
providing an offer to the participant when the first contest response does not equal the contest answer or when the participant has entered said survey response, wherein said offer is based on a current physical location of the participant or any combination of date, time, locality, temperature, altitude, speed, acceleration, and/or weather conditions;
accepting the participant referring a predetermined number of other participants to enter the contest or participate in the survey;
enabling acceptance of another contest response from the participant in addition to the first contest response when the participant refers a predetermined number of other participants to enter the contest or participate in the survey and when at least a second predetermined number of the other participants actually enter the contest or survey or both and enter their own contact information;
anonymously mining the database over the plurality of said contests and/or surveys to determine life style ranges having a highest number of responses associated with a particular life style question; and,
displaying a list of best qualifying ranges associated with the highest number of responses over the plurality of said contests and/or surveys to the sponsor.

23. The method of generating qualified sales leads using a computer of claim 1, wherein said offer is based on one or more of a current speed and acceleration associated with the participant, and wherein providing said offer to the participant comprises providing a different type of product or service offered based on one or more of said current speed and acceleration being within a particular range, over a particular speed or of high acceleration.

24. A method of generating qualified sales leads using a computer comprising:
requesting approval of one or more of a contest and a survey from an external server to obtain approval to run the contest or the survey or both the contest and the survey;
requesting approval for a participant to enter the contest based on government and location parameters, and one or more of current location of the participant, age of the participant and restrictions placed on the participant from said external server;
accepting a definition of said contest or survey or both contest and survey from a sponsor after said requesting approval;
displaying life style questions to the sponsor;
wherein the life style questions comprise information related to one or more of marital status, age and income;
accepting life style answers or answer ranges from the sponsor;
displaying the contest or survey or both contest and survey to a participant;
accepting a first contest response or survey response or both from the participant and contact information from the participant;
storing one or more of said first contest response, said survey response and said contact information from the participant in a database coupled with said computer, wherein said database holds information related to a plurality of contests and/or surveys;
accepting the first contest response, and when the first contest response is accepted, checking the first contest response against a contest answer and providing a prize to the participant when the first contest response equals the contest answer;
accepting life style responses from the participant and,
qualifying the participant based on comparing the life style responses to the life style answers or answer ranges and characterizing the participant as a qualified user when the life style responses are within a predetermined range with respect to the life style answers and,
providing an offer to the participant when the first contest response does not equal the contest answer or when the participant has entered said survey response, wherein said offer is based on one or more of a current speed and acceleration associated with the participant, and wherein providing said offer to the participant comprises providing a different type of product or service offered based on one or more of said current speed and acceleration being within a particular range, over a particular speed or of high acceleration;
accepting the participant referring a predetermined number of other participants to enter the contest or participate in the survey;
enabling acceptance of another contest response from the participant in addition to the first contest response when the participant refers a predetermined number of other participants to enter the contest or participate in the survey and when at least a second predetermined number of the other participants actually enter the contest or survey or both and enter their own contact information;
anonymously mining the database over the plurality of said contests and/or surveys to determine life style ranges having a highest number of responses associated with a particular life style question; and,
displaying a list of best qualifying ranges associated with the highest number of responses over the plurality of said contests and/or surveys to the sponsor.
